(19) United States
(12) Patent Application Publication
(10) Pub. No.: US 2010/0229875 A1
(43) Pub. Date: Sep. 16, 2010

(54) Apparatus and Method for Providing Proper Alignment of a Person's Airway

(75) Inventor: David T. Davis, Bethlehem, PA (US)

Correspondence Address: DUANE MORRIS LLP - Philadelphia;IP DEPARTMENT, 30 SOUTH 17TH STREET, PHILADELPHIA, PA, 19103-4196, US

(73) Assignee: WOODLARK CIRCLE, INC., Bethlehem, PA (US)

(21) Appl. No.: 12/721,129

(22) Filed: Mar. 10, 2010

Related U.S. Application Data
(60) Provisional application No. 61/160,365, filed on Mar. 16, 2009.

(51) Int. Cl. A61G 13/12

(52) U.S. Cl. 128/845

(57) ABSTRACT

An intubation pillow formed by a base cushion that forms a torso-support portion and defines a recess sized and shaped so as to provide proper alignment of the oral, pharyngeal, and laryngeal structures forming a person's airway. A head-support cushion that is positionable within the recess is provided so as to provide proper alignment of the oral, pharyngeal, and laryngeal structures that form a person's airway such that unlabored normal breathing may be maintained both prior to and after an intubation procedure.

This application claims priority from copending Provisional Patent Application Ser. No. 61/160,365, filed Mar. 16, 2009, and entitled Intubation Pillow with Adjustable/Removable Head Cushion.

### FIELD OF THE INVENTION

The present invention relates to medical devices, and more particularly to an intubation pillow suitable for both easing patient breathing and aiding in the alignment of the oral, pharyngeal, and laryngeal axes of the airway of an obese individual when reclining, as well as supporting that person's head prior to and after such intubation procedure.

### BACKGROUND OF THE INVENTION

It is critical to modern surgical procedures that the air passages of the patient be maintained in an open manner throughout the duration of the surgical procedure. During surgery, the ability of the body to maintain an adequate airway may be compromised, such that airway management procedures are necessary to ensure that the airway remains open and unobstructed. Endotracheal intubation is routinely carried out in operating rooms after the induction of anesthesia to secure a patient's airway through placement of a breathing tube in the individual's trachea in order to facilitate either spontaneous or controlled gas exchange, and to establish and maintain an adequate airway. The endotracheal intubation process requires an unobstructed airway that is obtained by aligning the oral, pharyngeal, and laryngeal structures of the patient's body. Endotracheal intubation is usually carried out without great difficulty using an instrument, such as a laryngoscope, that exposes the individual's vocal cords.

Endotracheal intubation is usually performed using a laryngoscope having a straight blade or a curved blade on a reclining and anaesthetized individual. During the endotracheal intubation, and prior to the individual being connected to a breathing machine, the individual's breathing is mechanically assisted by a health professional physically moving air into the individual's lungs with a ventilation bag. Often, an endotracheal intubation consists of extending the individual's neck and rotating the head backwards in order to achieve alignment of the individual's oral, pharyngeal, and laryngeal axes. In normal sized individuals, i.e., a person having an average height to weight ratio, the alignment of the oral, pharyngeal, and laryngeal axes is aided by placing a standard pillow or small foam pillow under the individual's head and neck. Next, the individual's mouth is opened and the laryngoscope is introduced into the mouth. Then, the individual's vocal cords are exposed allowing the endotracheal tube to be inserted through the exposed vocal cords. The tip of the endotracheal tube includes an inflatable collar that is inflated to create a seal on the inside of the trachea. The exterior end of the tube is connected to a breathing machine that sustains the individual's breathing while under the anesthesia. Once the breathing tube is in place, a surgical procedure may begin. Following the surgical procedure, the individual is gradually brought out of the anesthesia. At that time, the breathing machine is disconnected, the endotracheal breathing tube is removed, and the individual begins breathing on his own.

Unfortunately, performing an endotracheal intubation on an obese individual is more difficult. During the endotracheal intubation, the physician attempts to align the oral, pharyngeal and laryngeal axes so that the endotracheal tube can be visually guided into the proper position. At the same time, the physician mechanically assists the obese individual's breathing by physically moving air into the obese individual's lungs with a ventilation bag. When working with an obese individual positioned on a prior art intubation pillow, the physician is at a mechanical disadvantage due to the abdominal mass of the individual pressing upward against the individual's diaphragm. To ventilate an obese individual, the physician must exert enough force for air pressure to move the individual's diaphragm against the weight of the individual's abdominal mass. In an obese individual, however, the large abdominal mass may be difficult for the physician to displace. Of course, a similar problem occurs following the surgical procedure when the obese individual is brought out of anesthesia and must begin breathing on his own. The obese individual must breathe with enough force to displace his abdominal mass with his diagram. Since the individual is still anaesthetized to a certain extent, it may be difficult for attending personnel to get the individual to breathe with enough force.

The magnitude of the problem of managing the airways of obese individuals may be more fully appreciated in view of statistics that indicate a significant percentage of adults in the United States are obese. As a consequence, a need has arisen for an intubation pillow that is capable of easing the breathing of obese individuals in a supine position. A need has also arisen for an airway management apparatus that aids in the alignment of the oral, pharyngeal and laryngeal axes in obese individuals.

### SUMMARY OF THE INVENTION

The present invention provides an intubation pillow formed by a base cushion that forms a torso-support portion and defines a recess sized and shaped so as to provide proper alignment of the oral, pharyngeal, and laryngeal structures forming a person's airway. A head-support cushion that is positionable within the recess is provided so as to provide proper alignment of the oral, pharyngeal, and laryngeal structures that form a person's airway such that unlabored normal breathing may be maintained both prior to and after an intubation procedure.

In another embodiment of the invention, an inflatable intubation pillow is provided having an inflatable base cushion that forms a torso-support portion. The inflatable base cushion defines a recess that is sized and shaped so as to provide proper alignment of oral, pharyngeal, and laryngeal structures forming a person's airway. An inflatable head-support cushion that is positionable within the recess is provided such that when the inflated head-support cushion provides proper alignment of oral, pharyngeal, and laryngeal structures forming a person's airway such that unlabored normal breathing may be maintained both prior to and after an intubation procedure.

In a further embodiment of the invention, an inflatable intubation pillow is provided that includes an inflatable base cushion that forms a torso-support portion. The inflatable base cushion defines a recess that is sized and shaped so as to provide proper alignment of oral, pharyngeal, and laryngeal structures forming a person's airway. An inflatable head-support cushion is provided that is pivotally attached to a portion of the base cushion so as to be positionable within the recess. In this way, when the head-support cushion is inflated, it provides proper alignment of oral, pharyngeal, and laryngeal structures forming a person's airway such that unlabored normal breathing may be maintained both prior to and after an intubation procedure.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a perspective view of an intubation pillow formed in accordance with the present invention;

FIG. 2 is a cross-sectional view of the intubation pillow as shown along section 2-2 in FIG. 1;

FIG. 3 is a perspective view of an intubation pillow, similar to that shown in FIG. 1, but with the head cushion pivoted away from the base cushion about a living hinge;

FIG. 4 is a cross-sectional view of the intubation pillow shown in FIG. 3;

FIG. 5 is a side elevational view of the intubation pillow shown in FIG. 1, with a patient lying upon the pillow;

FIG. 6 is a side elevational view of the intubation pillow shown in FIG. 1, with a patient lying upon the pillow, with the head cushion pivoted away from the base cushion about a living hinge;

FIG. 7 is a side elevational view of the intubation pillow shown in FIG. 1, with the head cushion deflated on the base cushion; and

FIG. 8 is a side elevational view of the intubation pillow shown in FIG. 1 with the head cushion removed from the base cushion.

FIG. 9 is a flow chart illustrating a method of using the intubation pillow shown in FIG. 1, providing for proper alignment of a person's airway.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. When only a single machine is illustrated, the term “machine” shall also be taken to include any collection of machines that individually or jointly execute a set (or multiple sets) of instructions to perform any one or more of the methodologies discussed herein. In the claims, means-plus-function clauses, if used, are intended to cover the structures described, suggested, or rendered obvious by the written description or drawings for performing the recited function, including not only structural equivalents but also equivalent structures.

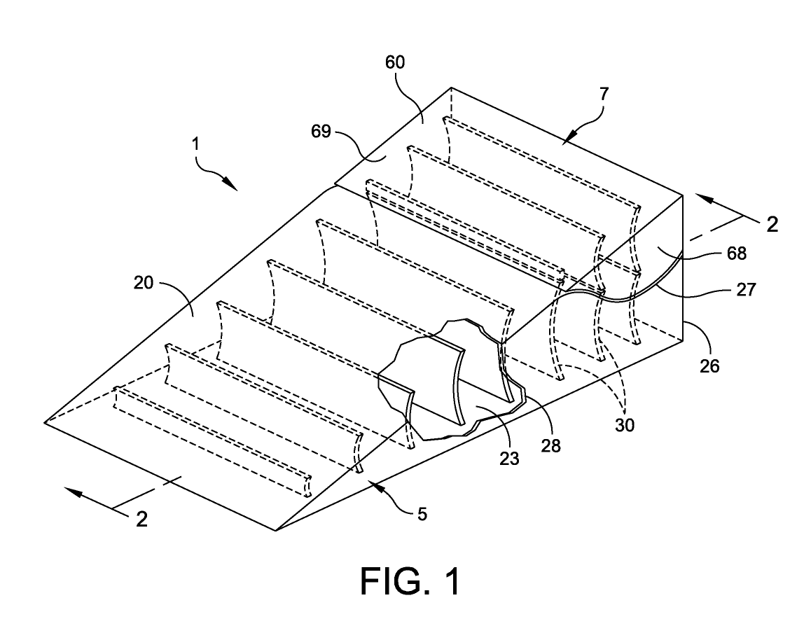

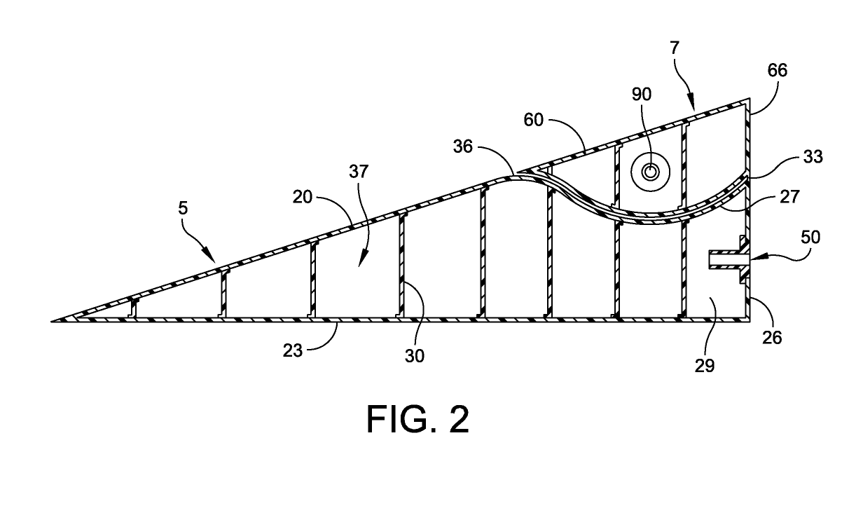

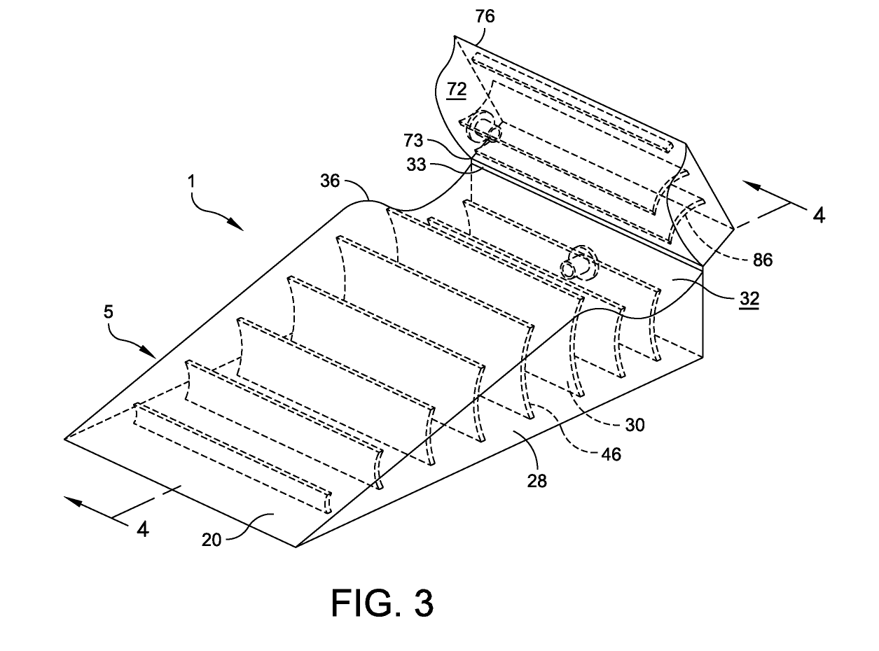

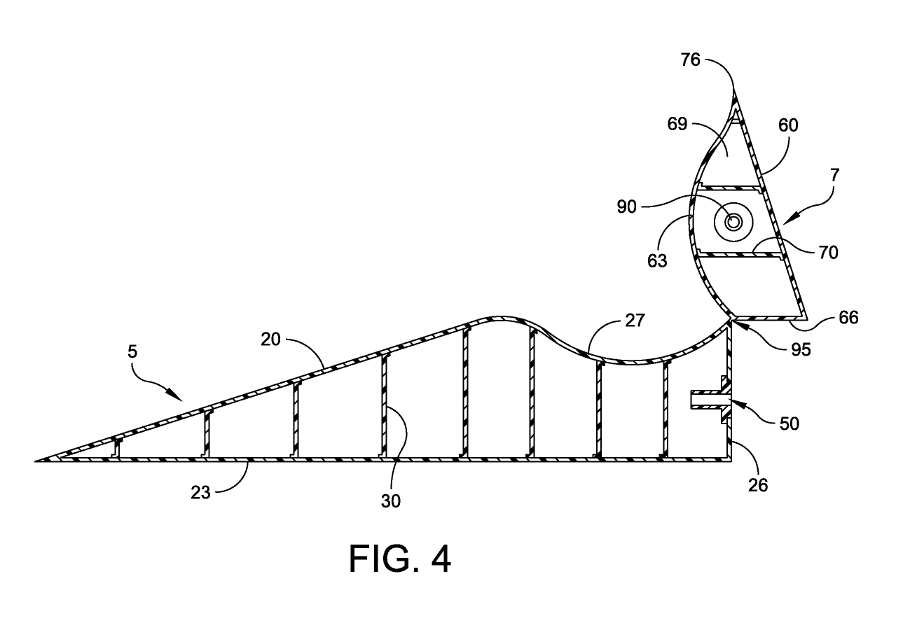

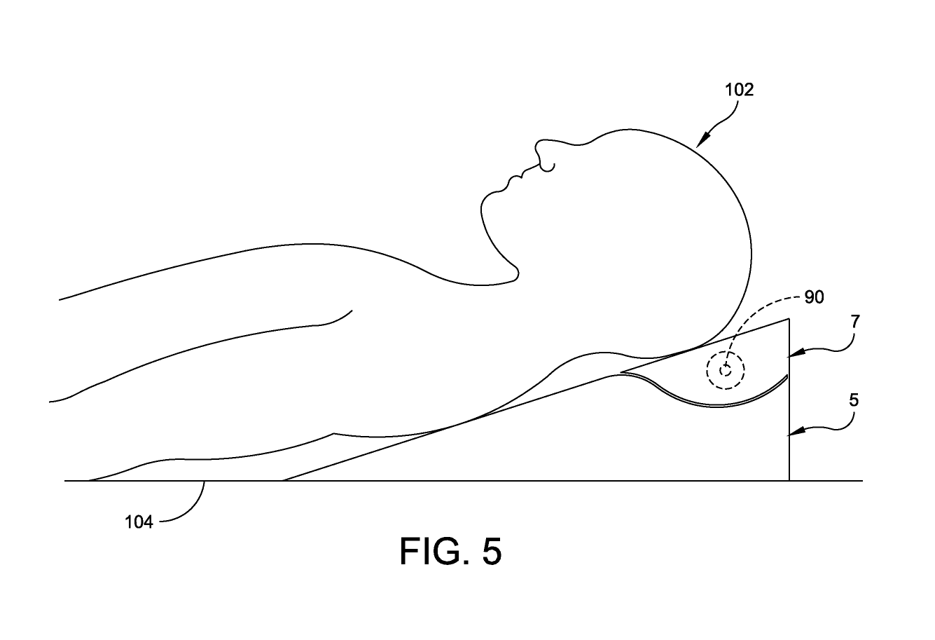

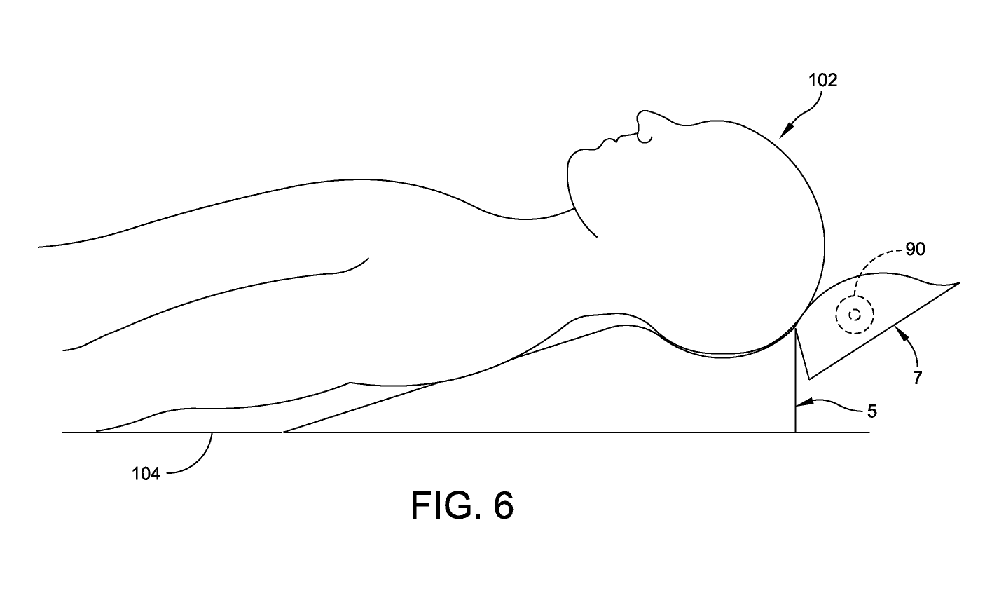

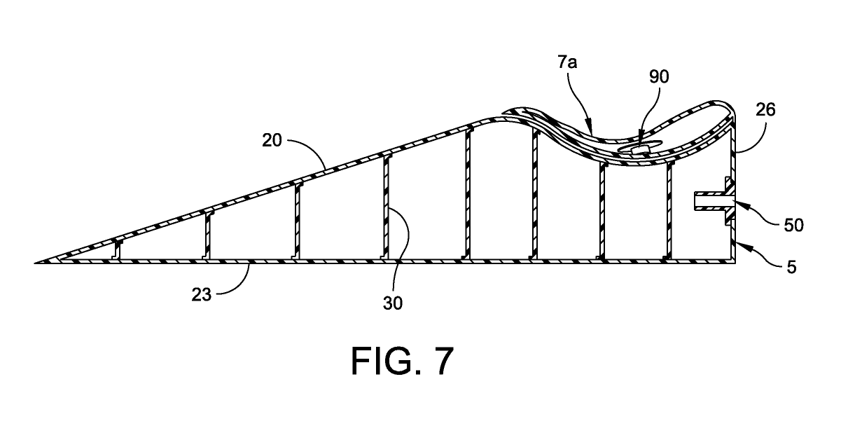

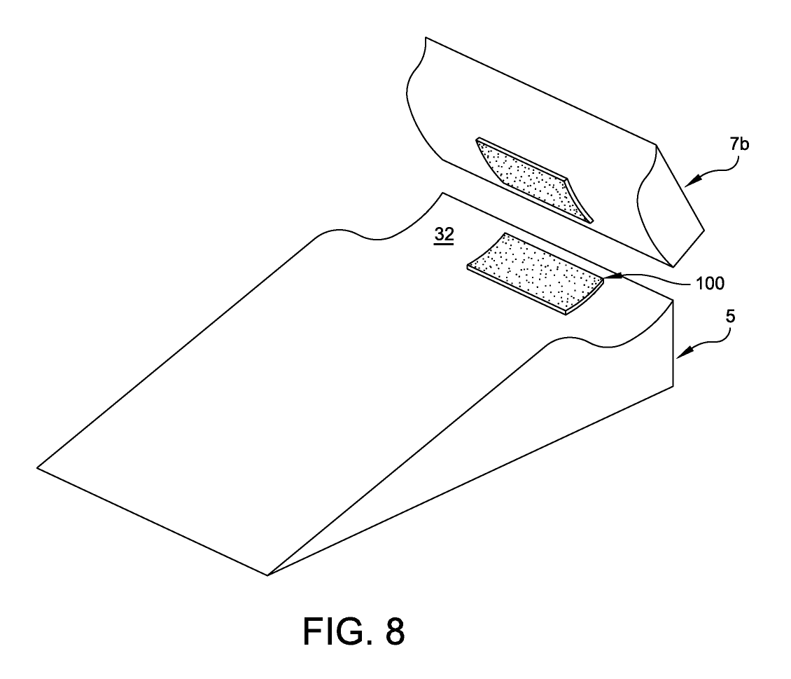

The present invention provides an inflatable cushion 1 for use in supporting a patient's back, head, and neck during an intubation procedure. Referring to FIGS. 1-8, inflatable intubation cushion 1 often comprises a wedge-shaped polyhedron having a base cushion 5 and a head cushion 7. Base cushion 5 includes a torso-support wall 20, a bottom wall 23, a back wall 26, a head-support wall 27 that is suitable for proper orientation of the oral, pharyngeal and laryngeal structures of the patient during an intubation procedure, two spaced-apart confronting triangular side walls 28, 29, and a plurality of interior stringers 30. Torso-support wall 20 is often formed from a discrete sheet of nylon scrim or the like, that may be coated on at least its outer surface with a water proof coating, such as any of the well known polymeric or elastomeric compounds that are known to be impervious to semi-solids and liquids, such as, blood, urine, feces, hospital strength disinfecting compounds, alcohol, or the like. Bottom wall 23 and back wall 26 may form portions of a single sheet of the same material or be discrete sheets. Side walls 28, 29 often comprise discrete sheets of the nylon scrim, that are arranged so as to be substantially parallel with one another and perpendicularly aligned with adjacent torso-support wall 20, bottom wall 23, and front wall 26. Head-support wall 27 defines a recessed portion of base cushion 5 that is defined by a concave surface 32 that extends from a top edge 33 of front wall 26 to an outwardly curved edge 36 defined at the junction between torso-support wall 20 and head-support wall 27. The curvature of concave surface 32 is selected so as to provide the proper intubation alignment of the oral, pharyngeal, and laryngeal structures forming a person's airway.

A plurality of transversely aligned air chambers 37 are structurally separated from one another and defined by stringers 30. Stringers 30 are affixed to, and extend between, the interior surfaces of torso-support wall 20 and bottom wall 23. Each stringer 30 comprises a substantially rectangular shape having a peripheral edge 46. Stringers 30 are attached to the interior facing surfaces of torso-support wall 20 and bottom wall 23 at regular intervals, so as to provide for reduced bulging of base cushion 5. A conduit 50 is provided in back wall 26, and is sized and shaped so as to be attached to a source of pressurized fluid (not shown). Alternatively, a self-sealing valve may be positioned through one of either side wall 28 or side wall 29 so as to provide easy accessibility. Conduit 50 is often formed so as to be in fluid communication with the interior of base cushion 5 so that air is evenly distributed throughout all of air chambers 37 during inflation, but may exit during deflation.

Head cushion 7 is positionable within the recessed portion of base cushion 5 that is defined by a concave surface 32, and includes a top wall 60, a bottom wall 63, a back wall 66, two spaced-apart confronting side walls 68, 69, and a plurality of interior stringers 70. Top wall 60 is also often formed from a discrete sheet of nylon scrim or the like, that may be coated on at least its outer surface with a water proof coating, such as any of the well known polymeric or elastomeric compounds that are known to be impervious to semi-solids and liquids, such as, blood, urine, feces, hospital strength disinfecting compounds, alcohol, or the like. Bottom wall 63 and back wall 66 may form portions of a single sheet of the same material or be discrete sheets. Side walls 68, 69 comprise discrete sheets of the nylon scrim, that are often arranged so as to be substantially parallel with one another and perpendicularly aligned with adjacent top wall 60, bottom wall 63, and back wall 66. Bottom wall 63 comprises a convex, curved surface 72 that extends from a top edge 73 of back wall 26 to an edge 76 defined at the junction between back wall 66 and bottom wall 67. The curvature of convex surface 72 is complementary to concave surface 32 of base cushion 5, such that when head cushion 7 is fully inflated and located within the concavity defined by concave surface 32, the patient's head is supported for proper alignment of the oral, pharyngeal, and laryngeal structures of a person's airway such that unlabored normal breathing may be maintained both prior to and after an intubation procedure.

A plurality of transversely aligned air chambers 77 are defined by, and structurally separated from one another by stringers 70. Stringers 70 are affixed to and extend between the interior surfaces of top wall 60 and curved bottom wall 63. Each stringer 70 comprises a substantially rectangular shape with a peripheral edge 86. Stringers 70 are attached to the interior facing surfaces of top wall 60 and bottom wall 63 at regular intervals, so as to provide for reduced bulging of head cushion 7. A conduit opening 90 is provided in back wall 66, and is sized and shaped so as to be attached to a source of pressurized fluid (not shown). Alternatively, a self-sealing valve may be positioned through one of either side wall 68 or side wall 69 so as to provide greater accessibility. Conduit opening 90 is often formed so as to be in fluid communication with the interior of head cushion 7 so that air is evenly distributed throughout all of the air chambers during inflation.

In one embodiment, head cushion 7 is pivotally fastened to base cushion 5 by a web 95 that forms a hinge. In this way, head cushion 7 may be pivoted about web 95, toward and away from concave surface 32. In another embodiment, head cushion 7a is fully fastened to base cushion 5 such that it may simply be deflated in order to facilitate the proper positioning of the patient's head during an intubation procedure. In another embodiment, head cushion 7b is wholly separate from base cushion 5 and may be held in place on concave surface 32 by any means of adhesion 100. The means of adhesion may be anything known in the art to attach head cushion 7b to base cushion 5 such as hook and felt fasteners, velcro, or even a sand-paper like substance that will provide resistance in the form of friction to prevent head cushion 7b from shifting away from base cushion 5. An advantage to having the head cushion 7d wholly separate from base cushion 5 is that during removal of head cushion 7b, while the patient is laying down on inflatable cushion 1, the patient does not have to lift his/her head. In this exemplary embodiment, head cushion 5 can simply be removed by sliding it underneath the patient's head without having to lift the head of patient.

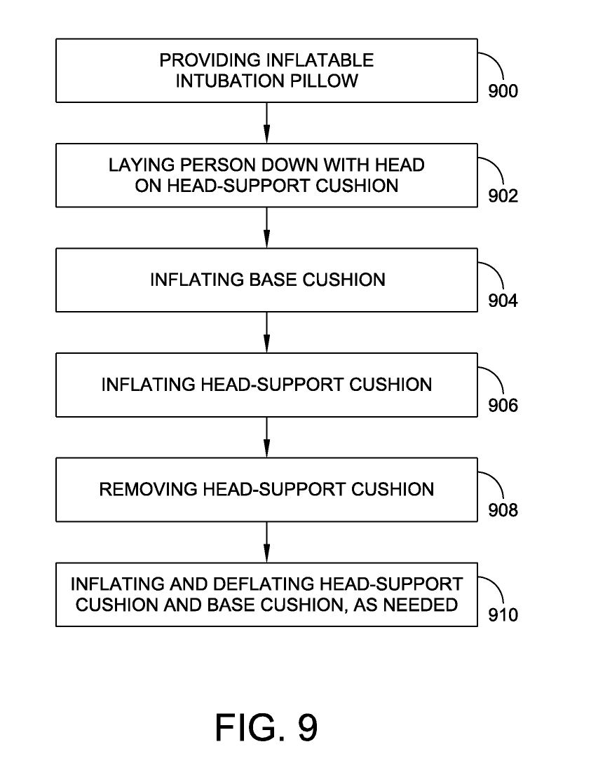

Referring to FIG. 9, a flow chart illustrating a method of using intubation pillow 1 as shown in FIG. 1 to provide proper alignment of a person's 102 airway is shown. Proper alignment, as used herein and throughout the specification, is preferably parallel alignment of a person's airway. However, as understood to those of ordinary skill in the art, substantially parallel or even something other than substantially parallel may be sufficient in order to place person 102 in the correct position to enable a doctor to place a tube inside the person's 102 airway to conduct the prescribed surgical procedure on the necessary person 102. Step 900 provides an inflatable intubation pillow 1 on a resting area 104. The resting area 104 may be a surgical table, bed, the ground, or any other surface where a person may lay down with their head in contact with the surface. In step 900, the inflatable intubation pillow 1 is preferably in a deflated state, but the inflatable intubation pillow 1 may already be inflated.

In step 902, person 102 is placed on the surface 104 preferably with their head on head-support cushion 7. Person 102 also may be placed with their head on base cushion 5, while the head-support cushion 7 is removed from underneath the head of person 102. Step 904 provides for the inflation of the base cushion 5, which in turn lifts at least the upper body of person 102 so that the person's 102 airway opens. Step 906 provides for the inflation of the head-support cushion 7. Step 904 and step 906 may occur in any order, as it is not important that the head-support cushion 7 or the base cushion 5 is inflated before the other. If head-support cushion 7 was initially placed under the head of person 102, then in step 908 removing the head-support cushion 7 to further provide parallel alignment of oral, pharyngeal, and laryngeal structures forming said person's 102 airway allowing for the placement of a tube into the trachea of said person. Step 908 removal may be performed by deflating head-support cushion 7, removing head-support cushion 7, or pivoting head-support cushion 7 about web 95, or a combination thereof. The person's 102 head should be laying directly on surface 2 of base cushion 5. At this point, the inflatable intubation pillow has physically and structurally transformed the elements of the person's 102 body to allow for person 102 to be in the optimal position for the placement of a tube inside the trachea in order to maintain an open airway if person becomes, or already is, unconscious or unable to breathe on their own. Inflatable intubation pillow allows for the person's 102 body to transform the interior structural body elements, such as the elongation of the person's 102 trachea, so that a tube can deliver necessary elements to the body such as Oxygen, anesthetics, or other gaseous medications.

Importantly, the present invention provides for the option inflating and deflating the head-support cushion 7 and/or the body cushion 5 as many times, and at any point during the procedure, as is necessary. For instance, if the doctor needs to gradually lower person 102 back to surface 104, the doctor may deflate head-support cushion 7 and/or body cushion 5 as needed to place person 102 in optimal position for the continuation of the surgery. The doctor may then inflate head-support cushion 7 and/or body cushion 5 when person 102 no longer needs to be in a position closer to surface 104, but instead needs to be lifted to further transform the physical elements of the person's 102 body so that the person's airway remains open.

It is to be understood that the present invention is by no means limited only to the particular constructions herein disclosed and shown in the drawings, but also comprises any modifications or equivalents within the scope of the claims.

What is claimed is:

1. An intubation pillow comprising:
a base cushion forming a torso-support portion and defining a recess sized and shaped so as to provide proper alignment of oral, pharyngeal, and laryngeal structures forming a person's airway; and
a head-support cushion that is positionable within said recess so as to provide proper alignment of oral, pharyngeal, and laryngeal structures forming a person's airway such that unlabored normal breathing may be maintained both prior to and after an intubation procedure.

2. The intubation pillow of claim 1, wherein said intubation pillow is in the form of a wedge-shaped polyhedron.

3. The intubation pillow of claim 1, wherein said base cushion has an upper surface, side surface, and an interface, wherein said interface is defined by a convex surface, said upper surface is defined by a substantially planar surface, and said side surface is defined by a substantially planar surface.

4. The intubation pillow of claim 1, wherein at least the upper surface of the intubation pillow is composed of a sheet of nylon, wherein at least the outer surface of said sheet of nylon is coated with a water proof coating.

5. The intubation pillow of claim 1, wherein said recess in said base cushion is defined by a concave surface that extends from a back wall of said base cushion to an outwardly curved edge of said base cushion.

6. The intubation pillow of claim 1, further including a plurality of stringers affixed to at least one of the interior surfaces of said base cushion.

7. The intubation pillow of claim 1, further comprising a conduit positioned through a wall of said base cushion, said conduit allowing fluid communication between the ambient exterior air and the interior air of said base cushion.

8. The intubation pillow of claim 1, further comprising a conduit positioned through the side wall of said head-support cushion, said conduit allowing fluid communication between the ambient exterior air and the interior air of said head-support cushion.

9. The intubation pillow of claim 1, further comprising a valve positioned through a wall of said head support cushion, said valve allowing fluid communication between the ambient exterior air and the interior air of said head-support cushion.

10. The intubation pillow of claim 1, further comprising at least one fastener to removably connect said base cushion and said head-support cushion.

11. The intubation pillow of claim 1, wherein said base cushion is inflatable and deflatable.

12. The intubation pillow of claim 1, wherein said head support cushion is inflatable and deflatable.

13. The intubation pillow of claim 1, wherein said base cushion and said head-support cushion provide parallel alignment of oral, pharyngeal, and laryngeal structures forming a person's airway.

14. An inflatable intubation pillow comprising:
an inflatable base cushion forming a torso-support portion and defining a recess sized and shaped so as to provide parallel alignment of oral, pharyngeal, and laryngeal structures forming a person's airway; and
an inflatable head-support cushion that is pivotally attached to a portion of said base cushion so as to be positionable within said recess such that when said head-support cushion is inflated and positioned within said recess, parallel alignment of oral, pharyngeal, and laryngeal structures forming a person's airway is achieved such that unlabored normal breathing may be maintained both prior to and after an intubation procedure.

15. The intubation pillow of claim 14, wherein said intubation pillow is in the form of a wedge-shaped polyhedron.

16. The intubation pillow of claim 14, wherein said base cushion has an upper surface, side surface, and an interface, wherein said interface is defined by a convex surface, said upper surface is defined by a substantially planar surface, and said side surface is defined by a substantially planar surface.

17. The intubation pillow of claim 14, wherein at least the upper surface of the intubation pillow is composed of a sheet of nylon, wherein at least the outer surface of said sheet of nylon is coated with a water proof coating.

18. The intubation pillow of claim 14, wherein said recess in said base cushion is defined by a concave surface that extends from a back wall of said base cushion to an outwardly curved edge of said base cushion.

19. The intubation pillow of claim 14, further comprising a plurality of stringers affixed to at least one of the interior surfaces of said base cushion.

20. The intubation pillow of claim 14, further comprising a valve positioned through a wall of said base cushion, said valve configured to allow fluid communication between the ambient exterior air and the interior air of said base cushion.

21. The intubation pillow of claim 14, further comprising a valve positioned through the side wall of said head-support cushion, said valve configured to allow fluid communication between the ambient exterior air and the interior air of said head-support cushion.

22. The intubation pillow of claim 14, further comprising a valve positioned through a wall of said head support cushion, said valve configured to allow fluid communication between the ambient exterior air and the interior air of said head-support cushion.

23. The intubation pillow of claim 14, wherein said base cushion and said head-support cushion are removably connected by at least one fastener.

24. A method for performing endotracheal intubation, comprising the steps of:
providing a deflated intubation pillow on a resting surface, said intubation pillow having an inflatable base cushion and an inflatable head-support cushion;
placing a person down to rest on said deflated intubation pillow, wherein the head of said person is resting directly on said head-support cushion and indirectly on said base cushion;
inflating said base cushion to lift at least the upper body of said person from said resting surface;
inflating said head-support cushion to further lift the head of said person from said resting surface; and
removing said head-support cushion, if necessary, to provide parallel alignment of oral, pharyngeal, and laryngeal structures forming said person's airway allowing for the placement of a tube into the trachea of said person.

25. The method for performing endotracheal intubation of claim 24, further comprising the steps of:
deflating said base cushion and said head-support cushion allowing for surgical procedures to occur where the lifting of the upper body of said person is not optimal for said procedures; and
inflating said base cushion and said head-support cushion to provide parallel alignment of oral, pharyngeal, and laryngeal structures forming said person's airway
allowing for the placement of a tube into the trachea of said person.
